(19) United States
(12) Patent Application Publication
(10) Pub. No.: US 2005/0223244 A1
(43) Pub. Date: Oct. 6, 2005

(54) Device, system and method for reduced power consumption

(76) Inventor: David Sinai, Petach-Tikva (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/811,864

(22) Filed: Mar. 30, 2004

(51) Int. Cl. G06F 1/26

(52) U.S. Cl. 713/300

(57) ABSTRACT

Briefly, some embodiments of the invention may provide devices, systems and methods for reduced power consumption. For example, a method in accordance with an embodiment of the invention may include setting an operating voltage supplied to a processor based on a mode of operation of said processor.

### BACKGROUND OF THE INVENTION

A device having a computing platform may include a processor and a Power Management Integrated Circuit (PMIC) to control the power provided to the processor and/or to other components of the device, e.g., by providing one or more preset levels of operating voltage to be supplied to the processor and/or other components. The one or more operating voltage levels are fixed and may be preset to accommodate the specific needs of the target components.

In some devices, the computing platform may be configured to operate in various modes of operation, for example, an active mode and a “sleep” mode, which may be either a “standby” mode or an “idle” mode. In the idle mode, the processor is partially active or unable to perform operations and all of the clocks of the processor are gated or operate at significantly lowered frequencies. In the standby mode, the processor is still able to maintain its state; however, as in the idle mode, substantially all of the clocks of the processor are gated.

The PMIC provides the processor with a constant voltage, regardless of the mode of operation. Internal components of the processor may be implemented to reduce power consumption in the standby and idle modes, e.g., by gating off paths within the processor. Unfortunately, this reduction in power consumption is limited due to inherent inefficiencies, for example, power leakage and/or heating, responsive to the operating voltage of the processor.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic block diagram illustration of a wireless communication system including one or more wireless communication devices able to operate in a reduced power consumption mode in accordance with exemplary embodiments of the invention;

FIG. 2 is a schematic block diagram illustration of a wireless communication device able to operate in a reduced power consumption mode in accordance with exemplary embodiments of the invention; and

FIG. 3 is a schematic flow-chart of a method of operation using reduced power consumption in accordance with exemplary embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

It should be understood that embodiments of the invention may be used in a variety of applications. Although the invention is not limited in this respect, embodiments of the invention may be used in conjunction with many apparatuses, for example, a transmitter, a receiver, a transceiver, a wireless communication station, a wireless communication device, a wireless Access Point (AP), a processor, a controller, a Power Management Integrated Circuit (PMIC), a power management controller or processor, a modem, a wireless modem, a personal computer, a desktop computer, a mobile computer, a laptop computer, a notebook computer, a Personal Digital Assistant (PDA) device, a tablet computer, a server computer, a cellular telephone, a wireless telephone, a Personal Communication Systems (PCS) device, a PDA device which incorporates a wireless communication device, or the like. Although part of the discussion herein may relate to a wireless communication device and to components of a wireless communication device, embodiments of the invention are not limited in this regard, and may be used in various other apparatuses, devices, stations, computing platforms, systems and/or networks.

The term “sleep mode” as used herein may include, for example, an idle mode, a standby mode, a power conservation mode, an efficiency mode, a reduced power mode, or other suitable modes of operations in which a processor is not fully operational and/or active. It is further noted that although part of the discussion herein may relate to active mode and sleep mode and the relationship therebetween, these terms are presented for exemplary purposes only. Embodiments of the invention are not limited in this regard, and may be used in conjunction with various other modes of operation, including other semi-active or partially-active operational modes.

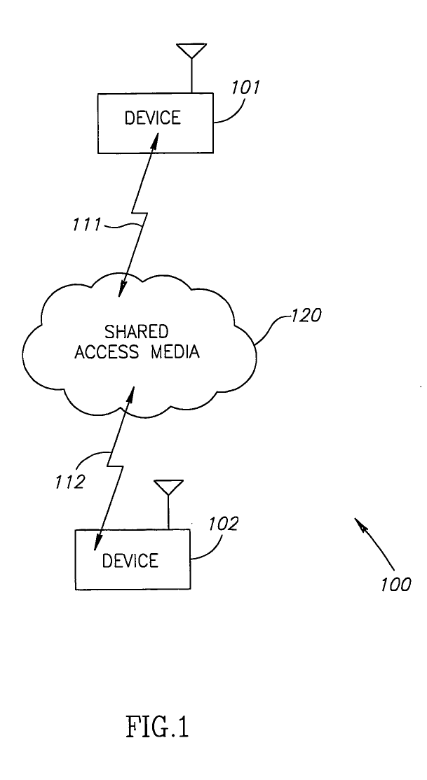

FIG. 1 schematically illustrates a block diagram of a wireless communication system 100 including one or more wireless communication devices able to operate in a reduced power consumption mode in accordance with exemplary embodiments of the invention. System 100 may include one or more wireless communication devices, for example, devices 101 and 102.

Device 101 and device 102 may communicate between themselves over a shared wireless media 120, which may include, for example, wireless communication links 111 and 112. For example, device 101 may communicate with one or more other stations of system 100 through link 111, and device 102 may communicate with one or more other stations of system 100 through link 112.

In some embodiments, device 101 and/or device 102 may include a PMIC, which may provide one or more levels of controlled voltage, and a processor which may receive the one or more controlled voltages from the PMIC. For example, the PMIC may provide the processor with a first operating voltage when the processor is in active mode. The PMIC may provide the processor with a second, lower voltage when the processor is not active, for example, when the processor in sleep mode, e.g., in idle mode or in standby mode.

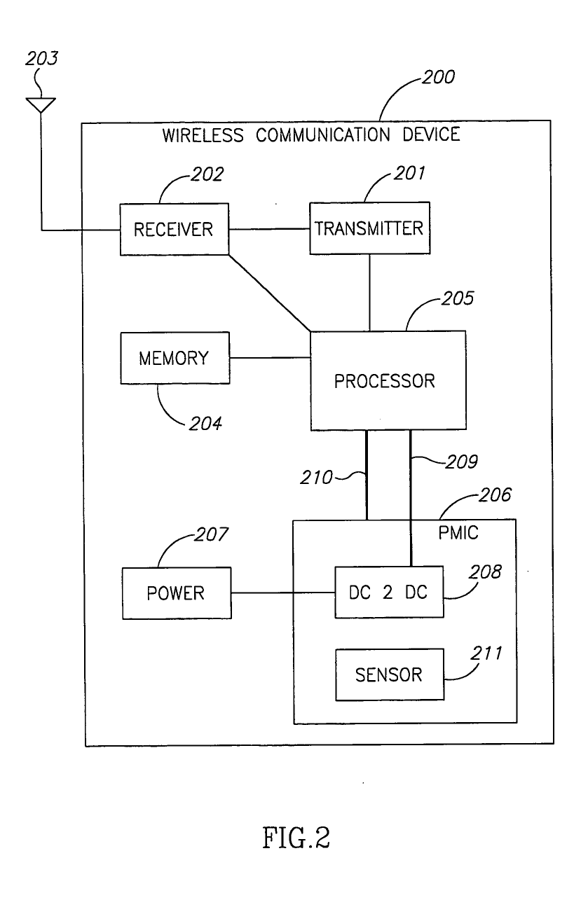

FIG. 2 schematically illustrates a block diagram of a wireless communication device 200 able to operate in a reduced power consumption mode in accordance with exemplary embodiments of the invention. Device 200 may be an example of device 101 and/or device 102. Device 200 may include a processor 205 in communication with a power management controller, for example, a PMIC 206, according to exemplary embodiments of the present invention, as described in detail below. Additionally, device 200 may include, for example, a transmitter 201, a receiver 202, an antenna 203, a memory unit 204 a power source 207, and/or any other suitable hardware components and/or software components as are known in the art and/or as described herein.

Transmitter 201 may include, for example, a Radio Frequency (RF) transmitter able to generate and send wireless communication signals. Receiver 202 may include, for example, a RF receiver able to receive wireless communication signals. In some embodiments, transmitter 201 and receiver 202 may be implemented in the form of a transceiver, a transmitter-receiver, or one or more units able to perform separate or integrated functions of sending and/or receiving wireless communication signals, blocks, frames, packets, messages and/or data.

Antenna 203 may include an internal and/or external RF antenna. In some embodiments, for example, antenna 203 may include a dipole antenna, a monopole antenna, an omni-directional antenna, an end fed antenna, a circularly polarized antenna, a micro-strip antenna, a diversity antenna, or any other type of antenna suitable for sending and/or receiving wireless communication signals, blocks, frames, packets, messages and/or data.

Memory unit 204 may include, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory units or storage units. In some embodiments, memory unit 204 may store data which may be used in-producing or processing signals which may be transmitted or received by device 200.

Power source 207 may include one or more batteries or power cells, which may be external and/or internal, rechargeable or non rechargeable. Power source 207 may provide power to be used by one or more components of device 200, for example, to transmitter 201, to receiver 202, and to PMIC 206, as described below.

Processor 205 may include, for example, a Central Processing Unit (CPU), a Digital Signal Processor (DSP), a microprocessor, a controller, a chip, a microchip, or any other suitable multi-purpose or specific processor or controller. In some embodiments, for example, processor 205 may perform calculation operations or processing operations, which may be used in producing signals which may be transmitted by station 200. Processor 205 may include a processor able to operate in various modes of operations, for example, active mode or sleep mode, e.g., idle mode or standby mode.

PMIC 206 may include, for example, a power management controller or circuit. PMIC 206 may receive from power source 207 an input voltage, for example, 3.6 V, and may reduce the input voltage, for example, using a Direct Current to Direct Current (DC2DC) converter 208 to produce one desired levels of output voltage, for example, 1.2 V. In some embodiments, other suitable voltage conversion units may be used instead of or in addition to DC2DC converter 208, for example, a Low Dropout (LDO) regulator unit. Although the input voltage from power source 207 may vary significantly due to changing parameters, e.g., charging level and/or temperature, the output voltage levels provided by DC2DC converter 208 are controlled to maintain accurate values regardless of the input voltage, as is known in the art. The one or more output voltage levels may be provided by PMIC 206 to processor 205, for example, using one or more power lines 209.

In some embodiments, one or more links 210 may connect between processor 205 and PMIC 206, and may be used to send and receive data signals or other signals between processor 205 and PMIC 206. For example, link 210 may be used to send to PMIC 206 a signal indicating a current operational mode of processor 205. In some embodiments, link 210 may include one or more communication buses, and may be connected to one or more nodes or “legs” of processor 205 which may be able to provide the signal indicating the current operational mode of processor 205.

In some exemplary embodiments of the invention, PMIC 206 may optionally include a sensor 211 able to sense the current mode of operation of processor 205. For example, sensor 211 may sense a current level of power or current consumed by processor 205, e.g., based on measuring the output power of PMIC 206 as is known in the art, and may determine the current mode of operation of processor 205 based on the sensed consumption level.

In some exemplary embodiments, in response to a signal indicating the current mode of operation of processor 205 and/or in response to sensor 211 sensing the current mode of operation, PMIC 206 may supply processor 205 with either a normal operating voltage or one or more levels of reduced operating voltages.

For example, PMIC 206 may sense, or may receive a signal indicating, that processor 205 is in standby mode, and in response PMIC 206 may supply processor 205 with a reduced operating voltage, e.g., a preset voltage in the range of 0.95 to 1.00 V. Similarly, PMIC 206 may sense, or may receive a signal indicating, that processor 205 is in idle mode, and in response PMIC 206 may supply processor 205 with a reduced operating voltage, e.g., a preset voltage in the range of 0.95 to 1.00 V.

In some embodiments, one or more links 210 may be used to transfer various instructions and/or data signals between processor 205 and PMIC 206. For example, PMIC 206 may send an interrupt signal, a reset signal, or one or more Inter Integrated Circuit (I2C) signals to processor 205 through link 210.

Similarly, processor 205 may be able, for example, using an embedded software module and/or hardware component, to send to PMIC 206 through link 210 a signal indicating that processor 205 is ready to, or is about to, modify its operational mode, e.g., an “alarm” signal indicating an anticipated change from sleep mode to active mode. Upon reception of such signal, PMIC 206 may supply to processor 205 a voltage, e.g., an increased voltage or a gradually increasing voltage, to accommodate the change in operational mode of processor 206.

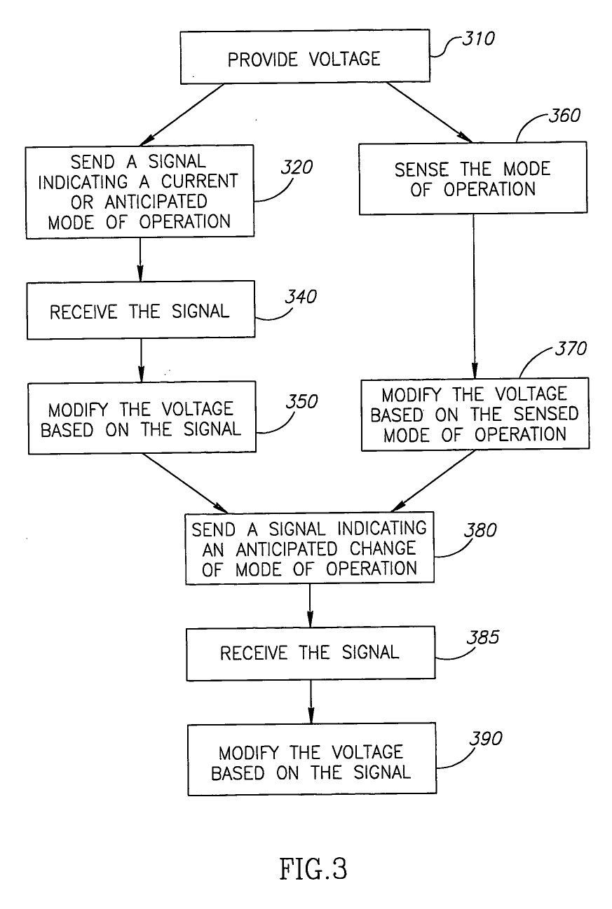

FIG. 3 is a schematic flow-chart of a method of operation using reduced power consumption in accordance with exemplary embodiments of the invention. The method may be used, for example, by system 100 of FIG. 1, by one or more of devices 101 and 102 FIG. 1, by device 200 of FIG. 2, by processor 205 and/or PMIC 206 of FIG. 2, by other suitable processors, controllers, PMIC units, wireless communication devices, stations, systems and/or networks.

As indicated at box 310, the method may begin by providing a first voltage, for example, from PMIC 206 to processor 205. At that time, processor 205 may be in a first mode of operation, for example, an active mode.

In one embodiment, as indicated at box 320, the method may optionally include sending a signal from processor 205 to PMIC 206, indicating a current or anticipated mode of operation of processor 205. The signal need not be a direct measurement of the current mode of operation; the signal may include, for example, a logical element or instruction. In some embodiments, the signal may be implemented using a flag or a one-bit indication, for example, a bit having a value of “one” may indicate an active mode, and a bit having a value of “zero” may indicate a sleep mode, or vice versa.

For example, processor 205 may change its mode of operation, e.g., from active mode to sleep mode, and may send a sleep mode indication to PMIC 206 through link 210. As indicated at box 340, the method may include receiving the signal by PMIC 206, and, as indicated at box 350, modifying or setting the voltage provided to processor 205 based on the received signal. For example, PMIC 206 may receive from processor 205 a signal indicating that processor 205 currently operates in sleep mode, and PMIC 206 may reduce the voltage provided to processor 205, e.g., from a preset voltage in the range of 1.2-1.3 V down to a preset voltage in the range of 0.95-1.00 V, or any other suitable voltage values or ranges, depending on a specific implementation

Additionally or alternatively, in some exemplary embodiments, as indicated at box 360, the method may include sensing the current mode of operation of processor 206. The sensing may be performed by PMIC 206, for example, using sensor 211. The sensing may include, for example, a measurement of a current or a power level supplied by PMIC 205 to processor 205. Then, as indicated at box 370, the method may include modifying or setting the voltage provided to processor 205 based on the sensed mode of operation. For example, PMIC 206 may sense that processor 205 operates in sleep mode, and PMIC 206 may reduce the voltage provided to processor 205, e.g., from a preset voltage in the range of 1.2-1.3 V down to a preset voltage in the range of 0.95-1.00 V. It is noted that these values are presented for exemplary purposes only, and that embodiments of the invention are not limited in this regard. For example, embodiments of the invention may reduce an operating voltage which may be up to 1.60 V into a reduced voltage which may be as low as 0.75 V. Other suitable values may be used in various specific implementations to achieve various functionalities.

As indicated at box 380, the method may optionally include sending a signal, for example, from processor 205 to PMIC 206, indicating an anticipated change of the operational mode of processor 205. For example, processor 205 may send an “alarm” signal to PMIC 206 through link 210, indicating that processor 205 is expected to go out of sleep mode and/or into active mode.

As indicated at box 385, PMIC 206 may receive the signal from processor 205, and, as indicated at box 390, may supply to processor 205 a voltage, e.g., an increased voltage or a gradually increasing voltage, to accommodate the change in operational mode of processor 205. For example, in response to a signal indicating an anticipated change of operational mode from sleep mode to active mode, PMIC 206 may gradually increase the voltage supplied to processor 205, e.g., from a preset voltage in the range of 0.95-1.00 V up to a preset voltage in the range of 1.2-1.3 V over a time period of about 10 microseconds.

It is noted that embodiments of the invention may include, for example, performing the operations indicated at boxes 360 and 370, and/or performing the operations indicated at boxes 320, 340 and 350. Other suitable operations or sets of operations may be used in accordance with embodiments of the invention.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, storage units and/or memory units, for temporary or long-term storage of data or in order to facilitate the operation of a specific embodiment.

Some embodiments of the invention may be implemented, for example, using a machine-readable medium or article which may store an instruction or a set of instructions that, if executed by a machine, for example, by device 101, by device 102, by device 200, by processor 205, by PMIC 206, or by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit (e.g., memory unit 204), memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

1. A method comprising:
setting an operating voltage supplied to a processor based on a mode of operation of said processor.

2. The method of claim 1, comprising determining an actual mode of operation of said processor, wherein setting comprises setting said operating voltage based on said actual mode of operation.

3. The method of claim 2, wherein determining comprises sensing a level of power supplied to said processor.

4. The method of claim 1, comprising receiving a signal indicating an anticipated mode of operation of said processor, wherein setting comprises setting said operating voltage based on said signal.

5. The method of claim 1, comprising reducing said operating voltage when said mode of operation is a sleep mode.

6. The method of claim 2, comprising reducing said operating voltage when said actual mode of operation is a sleep mode.

7. The method of claim 4, comprising reducing said operating voltage in response to said signal when said anticipated mode of operation is a sleep mode.

8. The method of claim 4, comprising increasing said operating voltage when said signal indicates that said processor is about to go out of sleep mode.

9. An apparatus comprising:
a controller to set an operating voltage supplied to a processor based on a mode of operation of said processor.

10. The apparatus of claim 9, wherein said controller is able to determine an actual mode of operation of said processor and to set said operating voltage based on said actual mode of operation.

11. The apparatus of claim 10, wherein said controller is able to sense a level of power supplied to said processor.

12. The apparatus of claim 9, wherein said controller is able to receive a signal indicating an anticipated mode of operation of said processor and to set said operating voltage based on said signal.

13. The apparatus of claim 9, wherein said controller is able to reduce said operating voltage when said mode of operation is a sleep mode.

14. The apparatus of claim 10, wherein said controller is able to reduce said operating voltage when said actual mode of operation is a sleep mode.

15. The apparatus of claim 12, wherein said controller is able to reduce said operating voltage in response to said signal when said anticipated mode of operation is a sleep mode

16. The apparatus of claim 12, wherein said controller is able to increase said operating voltage when said signal indicates that said processor is about to go out of sleep mode.

17. A wireless communication device comprising:
a processor;
a controller to set an operating voltage supplied to said processor based on a mode of operation of said processor; and
a dipole antenna to send and receive wireless communication signals.

18. The wireless communication device of claim 17, wherein said controller is able to determine an actual mode of operation of said processor and to set said operating voltage based on said actual mode of operation.

19. The wireless communication device of claim 18, wherein said controller is able to sense a level of power supplied to said processor.

20. The wireless communication device of claim 17, wherein said controller is able to receive a signal indicating an anticipated mode of operation of said processor and to set said operating voltage based on said signal.

21. The wireless communication device of claim 17, wherein said controller is able to reduce said operating voltage when said mode of operation is a sleep mode.

22. A wireless communication system comprising:
a first wireless communication device; and
a second wireless communication device comprising:
a processor;
a controller to set an operating voltage supplied to said processor based on a mode of operation of said processor; and
a dipole antenna to send and receive wireless communication signals.

23. The wireless communication system of claim 22, wherein said controller is able to determine an actual mode of operation of said processor and to set said operating voltage based on said actual mode of operation.

24. The wireless communication system of claim 22, wherein said controller is able to receive a signal indicating an anticipated mode of operation of said processor and to set said operating voltage based on said signal.

25. A machine-readable medium having stored thereon a set of instructions that, if executed by a machine, cause the machine to perform a method comprising:
setting an operating voltage supplied to a processor based on a mode of operation of said processor.

26. The machine-readable medium of claim 25, wherein the instructions result in determining an actual mode of operation of said processor, and wherein the instructions that result in setting result in setting said operating voltage based on said actual mode of operation.

27. The machine-readable medium of claim 25, wherein the instructions result in receiving a signal indicating an anticipated mode of operation of said processor, and wherein the instructions that result in setting result in setting said operating voltage based on said signal.
